(19) United States
(12) Patent Application Publication
(10) Pub. No.: US 2008/0311946 A1
(43) Pub. Date: Dec. 18, 2008

(54) SYSTEM AND METHOD FOR DYNAMICALLY PROVIDING CONTROL PLANE CAPACITY

(75) Inventor: RICHARD E. BRITTON, WINFIELD, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/762,244

(22) Filed: Jun. 13, 2007

(51) Int. Cl. H04Q 7/20

(52) U.S. Cl. 455/518

(57) ABSTRACT

A system and method for dynamically provisioning control plane signaling capacity for each base site in a communication system. Each base site is configured to monitor at least one criteria, such as a control plane traffic throughput level, of at least one control channel. If the criteria indicate that that additional control plane signaling capacity is required, the base site assigns an available communication channel as an additional control channel to transmit control plane signaling and causes selected talk groups to move to the additional channel. If the criteria indicate that the control plane signaling capacity should be decreased, the base site selects a control channel to be de-assigned from the control plane and causes talk groups associated with the selected control channel to another available control channel.

### TECHNICAL FIELD OF THE DISCLOSURE

This disclosure relates generally to communication systems and more particularly to a system and method for dynamically providing control plane capacity.

### BACKGROUND OF THE DISCLOSURE

Communication systems typically include a plurality of dispatch consoles and communication units, such as mobile or portable radio units, that are geographically distributed among various base sites and console sites. The communication units wirelessly communicate with the base sites and each other, and are often logically divided into various talkgroups. Communication systems may be organized as trunked systems, where a plurality of radio frequency (RF) communication resources are allocated amongst multiple users or groups by assigning the base sites within a coverage area on a call-by-call basis, or as conventional (non-trunked) systems where RF communication resources are dedicated to one or more users or groups. In trunked systems, or in mixed trunked and conventional systems, there is usually provided a central controller/server (sometimes called a “zone controller”) for allocating RF communication resources among a group of sites.

One set of industry standards commonly used for communication systems is referred to as Project 25, developed by the Association of Public Communications Officials (APCO). In Project 25 compliant systems, the communication resources are generally comprised of a plurality of communication channels. Furthermore, in accordance with Project 25 standards, a single communication channel at each base site is typically designated as a control channel to provide control plane signaling while remaining channels are designated as traffic channels to carry call information.

However, each communication channel has only a finite amount of bandwidth. As a result, the number of traffic channels that can be provided at a single base site is limited by the bandwidth of the single assigned control channel. For example, in Project 25 systems, a control channel can only support approximately 30 traffic channels.

Currently, if a Project 25 system requires more than 30 traffic channels in a geographic area, one solution is to overlay multiple base sites on top of one another. This solution, however, is undesirable as it significantly increases the cost and complexity required to cover a given area.

Another proposed solution has been to simply assign multiple control channels for each base site. There are drawbacks to this solution as well. For example, having multiple control channels provisioned at all times results in a wasteful allocation of resources when call capacity is low. It is also cumbersome to provided redundancy in communication systems having multiple dedicated control channels, as a dedicated backup channel is typically required to be reserved for each control channel.

### BRIEF DESCRIPTION OF THE FIGURES

Various embodiments of the disclosure are now described, by way of example only, with reference to the accompanying figures.

FIG. 1 shows one embodiment of a communication system in accordance with the present disclosure.

FIG. 2 shows one embodiment of a base site in accordance with the present disclosure.

FIG. 3 shows one embodiment of a site controller in accordance with the present disclosure.

FIG. 4 shows one embodiment of an outbound queue in an APCO Project 25 compliant system.

FIG. 5 shows one embodiment of a talkgroup use database in accordance with the present disclosure.

FIG. 6 shows one embodiment of a talkgroup allocation database in accordance with the present disclosure.

FIG. 7 shows one embodiment for dynamically provisioning control plane capacity in accordance with the present disclosure.

FIG. 8 shows one embodiment for managing roaming communication units in accordance with the present disclosure.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help improve the understanding of various embodiments of the present disclosure. Also, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions with respect to their corresponding respective areas of inquiry and study except where specific meaning have otherwise been set forth herein.

### DETAILED DESCRIPTION OF THE DISCLOSURE

The present disclosure provides a system and method for dynamically provisioning control plane signaling capacity for each base site in a communication system. In the communication system, each base site is configured to communicate with a plurality of talkgroups via a plurality of communication channels, wherein at least a portion of the plurality of communication channels are capable of being configured as control channels for transmitting control plane signaling between the base site and the plurality of talkgroups.

In accordance with the present disclosure, each base site is configured to monitor at least one criteria, such as a control plane traffic throughput level, of at least one control channel. If the criteria indicates that that additional control plane signaling capacity is required, the base site assigns an available communication channel as an additional control channel to transmit control plane signaling, determines a set of talkgroups to be serviced by the additional control channel, and initiates transmission of a move message to each talkgroup in the set of talkgroups instructing communication units within the set of talkgroups to begin utilizing the additional communication channel for control plane signaling.

If the criteria indicates that the control plane signaling capacity should be decreased, the base site selects a control channel to be de-assigned from the control plane, and initiates transmission of a move message to a set of talkgroups associated with the selected control channel instructing the communication units within the set of talkgroups to begin utilizing a control channel other than the selected control channel for control plane signaling. The base site then de-assigns the selected control channel from the control plane.

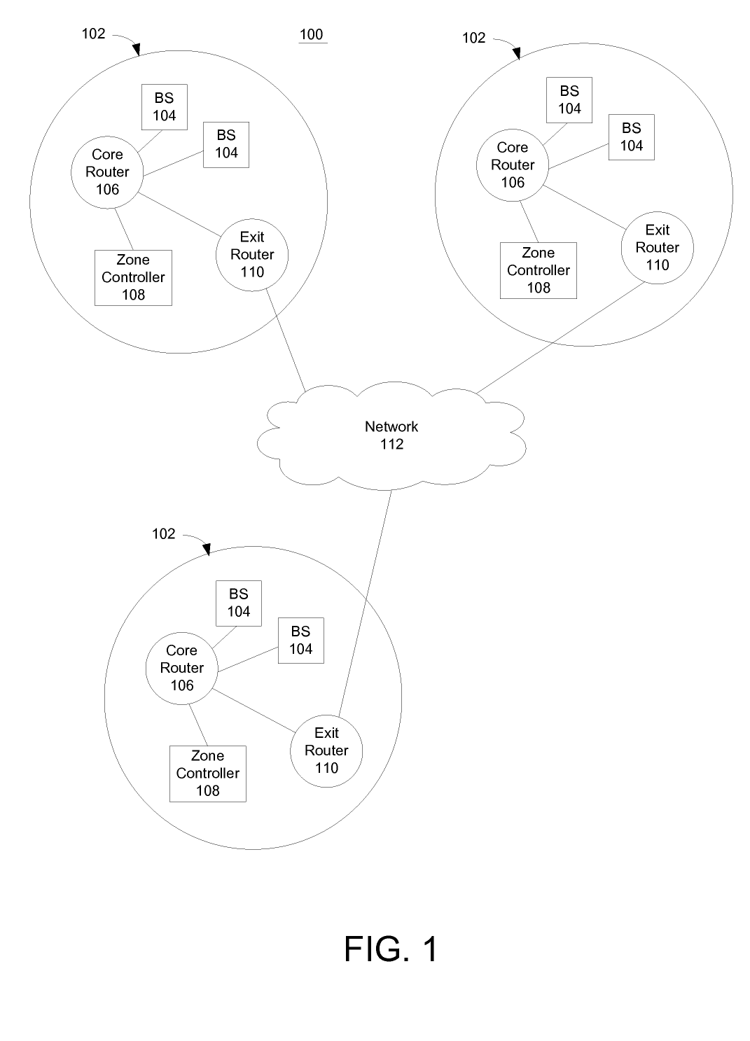

Let us now discuss the present disclosure in greater detail by referring to the figures below. FIG. 1 shows one embodiment of a communication system 100 having a plurality of zones 102. Each zone 102 comprises a plurality of base sites 104 that are in communication with a core router 106. The core router is also coupled to a zone controller 108. The zone controller 108 manages and assigns Internet Protocol (IP) multicast addresses for payload (voice, data, video, etc.) and control messages between and among the various base sites 104. The zone controller 108 is also responsible for assigning call channels at the base sites 104. Each zone controller 108 is also coupled with an exit router 110. The exit routers 110 from each zone 102 are coupled to one another via network 112 to allow for interzone communications.

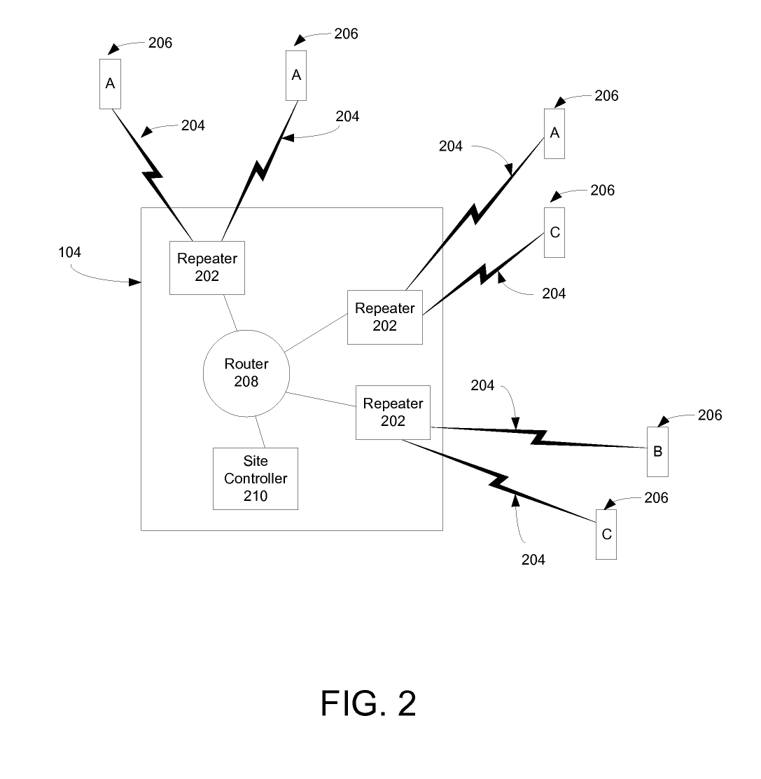

As shown in FIG. 2, each base site 104 includes at least one repeater 202 that communicates, using wireless communication resources 204, with communication units 206 within a specific coverage area. Each repeater 202 is also coupled, for example, via Ethernet, to an associated router 208, which is in turn coupled to the core router 106. Each router 208 may also be coupled to a site controller 210 configured to handle call channel assignments for its respective base site 104 in the event the base site 104 is unable to communicate with the zone controller 108. In one embodiment, the various components within each zone may be coupled using T1 lines, E1 lines, fiber optic lines, wireless links, Ethernet links, or any other suitable means for transporting data between the various components.

The communication units 206 may be mobile or portable wireless radio units, cellular radio/telephones, video terminals, portable computers with wireless modems, or any other wireless devices. The communication units 206 may also be arranged into talkgroups having corresponding talkgroup identifications as known in the art. In FIG. 2, three separate talkgroups are illustrated, identified by labels “A,” “B,” and “C.” However, any number of talkgroups having corresponding talkgroup identifications may be established within the system 100.

Practitioners skilled in the art will appreciate that the system 100 may also include various other elements not shown in FIGS. 1 and 2. For example, although each zone 102 is illustrated as having two base sites 104, and each base site 104 is illustrated having three repeaters 202, each zone 102 may include any number of base sites 104 and each base site 104 may include any number of repeaters 202. Each zone 102 may also include consoles sites having one or more dispatch consoles. Each base site may also be configured to provide simulcast transmissions using one or more comparators. The system 100 may also be linked to a public switched telephone network (PSTN), a paging network, a facsimile machine, or the like. The system 100 may also be connected to a number of additional content sources, such as the Internet or various Intranets.

The wireless communication resources 204 used for communication between the repeaters 202 and the communication units 206 may include any type of communication resource such as, for example, RF technologies, including, but not limited to Code Division Multiple Access (CDMA), Time Division Multiple Access (TDMA), Frequency Division Multiple Access (FDMA), Orthogonal Frequency Division Multiple Access (OFDMA), and the like. Other wireless technologies, such as those now known or later to be developed and including, but not limited to, infrared, Bluetooth, electric field, electromagnetic, or electrostatic transmissions, may also offer suitable substitutes.

In one exemplary embodiment in accordance with the present disclosure, the wireless communication resources 204 comprise multiple communication channels used for transmissions from the base sites 104 to communication units 206 (outbound link) and transmissions from the communication units 206 to the base sites 104 (inbound link). As would be understood by one skilled in the art, the nature of the communication channels will differ depending on the type of system being used. For example, in a FDMA system, each communication channel is comprised of a pair of frequency carriers. One frequency carrier of the pair is used for the outbound link while the other frequency carrier of the pair is used for the inbound link. In TDMA systems, however, each frequency carrier is divided into a plurality of time slots, each of which may be allocated to a separate call.

Communications between the base site 104 and the communication units 206 are also divided into a data plane and a control plane. In particular, the data plane is used for user information (such as voice, data, video, or the like) from a communication unit 206 to a base site 104, as well as from a base site 104 to a communication unit 206. The control plane is then used for transmitting various call control signaling such as call requests, call grants, call assignment information, communication unit registrations, and various other types of control signaling that is well known in the art.

For example, when a communication unit 206 is keyed to initiate a call, the zone controller 108 assigns the call to an available communication channel (also referred to as a traffic channel). The channel assignment is then advertised to the communication units via one or more communication channels allocated for control plane signaling (also referred to as a control channel). Upon receiving the channel assignment, the communication unit 206 which requested the call begins transmitting call information to the base site 104 using the inbound link of the assigned traffic channel. Other communication units 206 authorized to receive the transmitted call (i.e., communication units in the same talkgroup) also obtain the channel assignment from the control channel and begin listening to the call on the outbound link of the traffic channel.

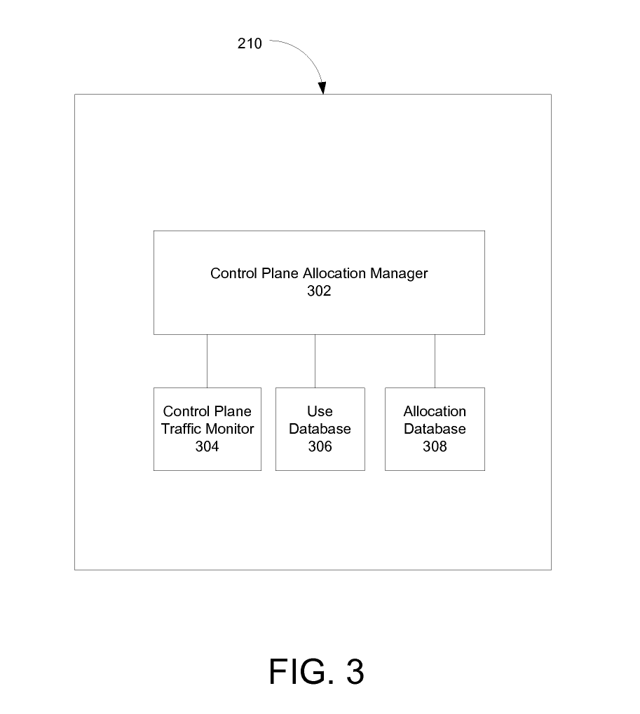

In accordance with the present disclosure, each base site 104 in the communication system 100 is configured to dynamically increase or decrease the number of communication channels provisioned for control plane signaling to accommodate changes in call activity. In one exemplary embodiment, this functionality is performed by the site controller 210 for the respective base site 104, although it would be understood that the functionality may be implemented in other components within the base site. More particularly, as shown in FIG. 3, the site controller 210 includes a control plane allocation manager 302 that is coupled to a control plane traffic monitor 304, a talkgroup use database 306, and a talkgroup allocation database 308.

The control plane allocation manager 302 is configured to assign and de-assign communications to the control plane based on information obtained from the control plane traffic monitor 304, the talkgroup use database 306, and the talkgroup allocation database 308. The manner in which such assignment and de-assignment is performed is described in more detail below.

The control plane traffic monitor 304 is configured to assess the throughput level of the control plane at a given time. The throughput level may be based on an assessment of an outbound throughput level, an inbound throughput level, or a combination thereof

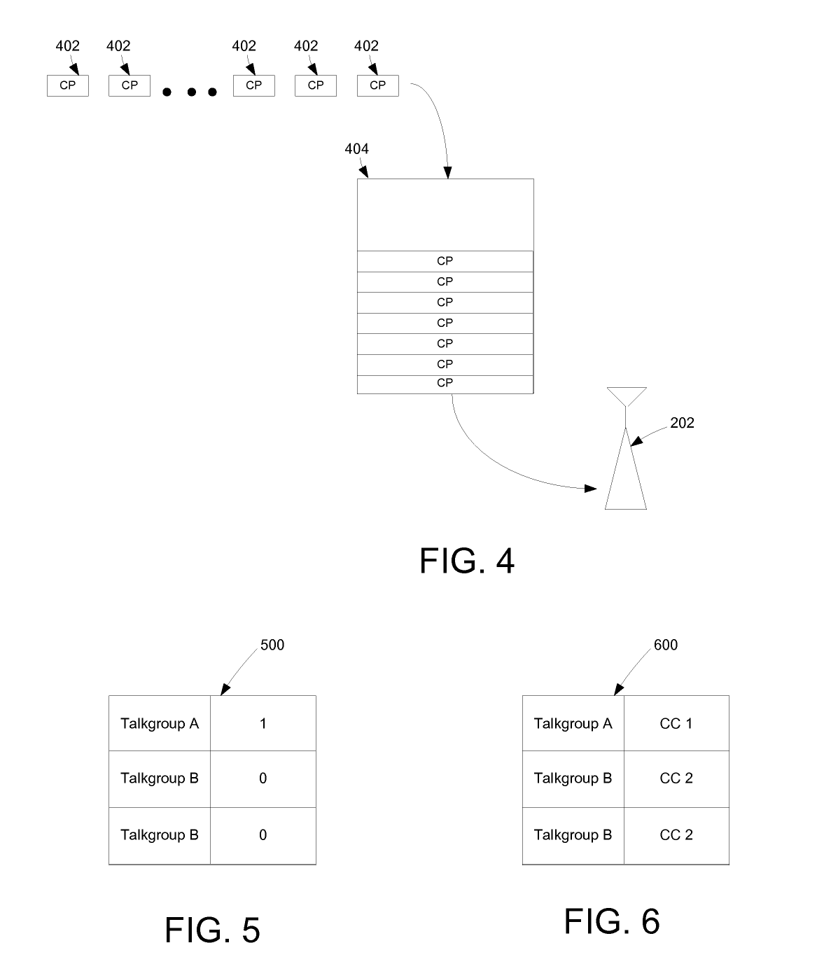

The outbound throughput level may be assessed using various methods. As one example, in an APCO Project 25 compliant system, the outbound throughput level may be determined by monitoring an outbound queue for each control channel. As shown in FIG. 4, control packets 402 which are to be broadcast on a control channel are placed in a queue 404 based on a priority level corresponding to each control packet. Thus, higher priority control packets are positioned earlier in the queue than lower priority control packets. Additionally, the bit transmission rate in an APCO Project 25 compliant system is generally a set known value. Thus, the amount of time required to transmit a particular control packet can be calculated based on the size of the particular control packet. Accordingly, monitoring the number and type of control packets 402 within the outbound queue 404 can be used to provide a sufficiently accurate determination of the time delay until the lowest priority control packets in the queue are to be transmitted, and therefore, the rate at which such low priority control packets will be transmitted on the corresponding control channel.

Alternatively, rather than monitoring the control packets in the outbound queue 404 to determine transmission delays for the lowest priority control packets, the position of other higher priority control packets within the outbound queue 404 may be monitored to determine transmission delays for such higher priority control packets. Thus, it should be understood that the outbound throughput level may be based on transmission delays for any control packet type and/or priority level in the communication system.

Of course, other methods may also be used to monitor the outbound throughput level. For example, rather than monitoring an outbound queue, the control plane traffic monitor 304 may directly monitor the time between when a certain control packet is placed into the outbound queue in comparison to the time when such a control packet is transmitted on the control channel. The control plane traffic monitor may also be configured to generate and transmit dedicated monitoring packets solely to determine the delay between generation and transmission of such dedicated monitoring packets.

The inbound throughput level, on the other hand, may be determined by monitoring transmissions of inbound packets on a control channel. For example, in one embodiment, the inbound throughput level may simply be based on the total number of inbound control packets received on a particular control channel during a predetermined amount of time. Alternatively, the inbound throughput level may be based on the total combined size (e.g., number of bits) of the inbound packet data received during a predetermined amount of time. Of course, as with the outbound scenario, the control plane traffic monitor 304 may be configured to count all inbound control packets to obtain an inbound throughput level, or to count only a predetermined type and/or priority of inbound control packets.

The use database 306 is configured to record and maintain information regarding the amount of bandwidth being utilized by each talkgroup that is registered with the respective base site. In one embodiment, the use database 306 may identify whether each talkgroup is a frequently used talkgroup. For example, as shown in FIG. 5, the use database 306 may comprise a table 500 in which each talkgroup is identified as either being a frequently used talkgroup or not being a frequently used talkgroup using a binary designation (i.e., “1” for frequently used talkgroup and “0” for not frequently used talkgroup). Thus, in the example shown in FIG. 5, talkgroup A is identified as being a frequently used talkgroup and talkgroups A and B are identified as being not frequently used talkgroups.

Whether a particular talkgroup is a frequently used talkgroup may be based on various communication criteria such as the number of calls placed by the talkgroup in a certain amount of time, the amount of data plane traffic between members of the talkgroup, the amount of control plane traffic utilized for the talkgroup, or any combination thereof The designation of whether a talkgroup is a frequently used talkgroups may then be based on whether such communication criteria exceeds certain thresholds. Of course, the use database 306 may also be configured to categorize talkgroups into one of any number of use levels based on any number of thresholds for the communication criteria described above.

In another embodiment, the use database 306 may also be configured to rank or categorize the various talkgroups present at the base site based on respective amounts of bandwidth utilized by each talkgroup. Thus, rather than determining whether certain communication criteria exceed predetermined levels, the use database 306 may simply identify a certain subset of the talkgroups that utilize the most bandwidth as being frequently used talkgroups. In yet another embodiment, the use database 306 may simply record the communication criteria described above without providing any classifications.

As will be described in more detail below, the use database 306 is utilized by the control plane allocation manager 302 for determining how to efficiently provision talkgroups among multiple control channels in the communication system. Accordingly, it is desirable that the use database 306 is updated continuously in real time. However, it is understood that the use database 306 may also be updated periodically or at preset times. Alternatively, the use database 306 may be set and/or updated manually by a network administrator.

The allocation database 308 is configured to record and maintain information identifying which talkgroups are being serviced by which control channel at a give time. One example of an allocation database 308 is shown in FIG. 6. In this example, the allocation database 308 comprises a table 600 that provides a correlation between each talkgroup and the respective control channel to which that talkgroup is assigned. Thus, in the example shown in FIG. 6, talkgroup A is assigned to control channel 1 and talkgroups B and C are assigned to control channel 2.

Although the use database 306 and the allocation database 308 are shown as two distinct databases, it would of course be understood that the use database 306 and the allocation database 308 may comprise a single logical database, or may be distributed among a plurality of databases. It should also be understood that the use database 306 and the allocation database 308 need not utilize tables and may alternatively be configured using any other known formatting.

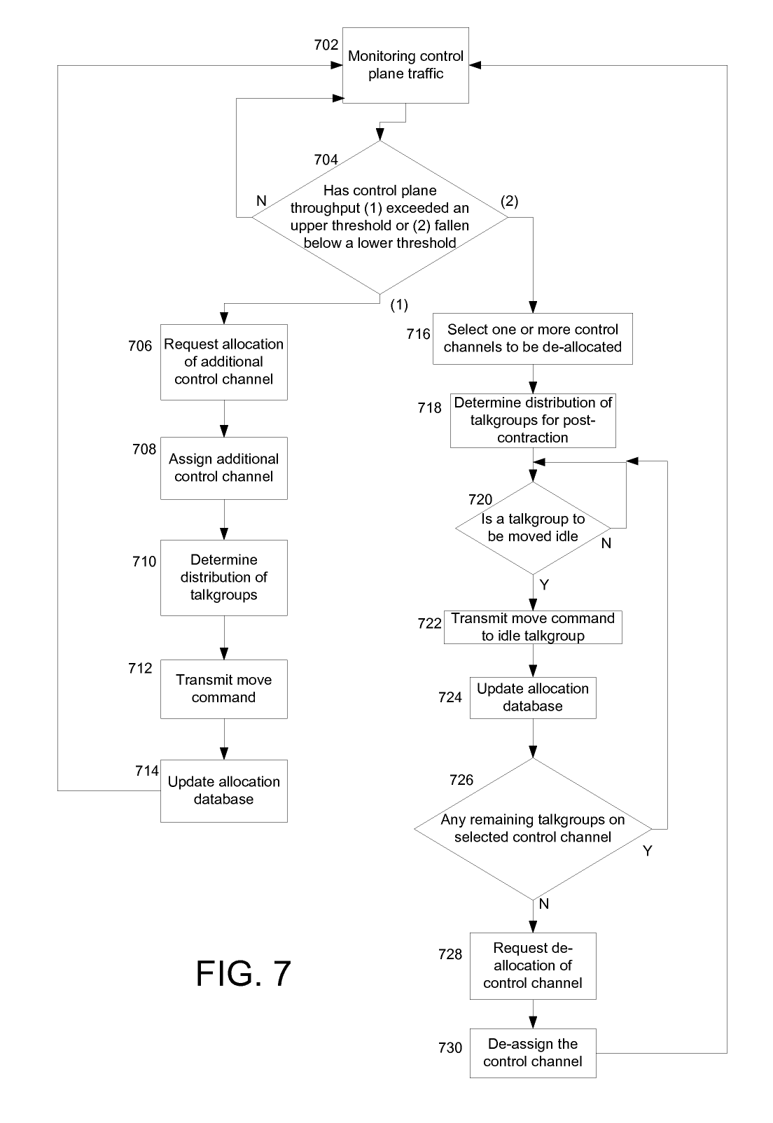

FIG. 7 illustrates one exemplary embodiment for allocating control channels in accordance with the present disclosure. In step 702, the control plane traffic monitor 304 monitors the control plane traffic throughput levels. As noted above, this may be accomplished by monitoring at least one of the outbound throughput or the inbound throughput for each communications channel assigned to the control plane at a base site 104. Monitoring of the control plane traffic throughput level may be performed on a continuous basis, periodically, at preset times, or upon the occurrence of preset events.

In step 704, the control plane allocation manager 302 determines, for each control channel, whether the throughput of the control channel has exceeded an upper threshold level or whether the throughput for the control channel has fallen below a lower threshold level. For example, in the case of an APCO Project 25 compliant system, determining whether the throughput has exceeded an upper threshold level may include determining that either, or both, (1) the number of control packets in an outbound queue has exceeded a predetermined amount or (2) the number of inbound control packets received over a certain amount of time has exceeded a predetermined amount. Similarly, determining that the throughput has fallen below a lower threshold level may include determining that either, or both, (1) the number of control packets in an outbound queue has fallen below a predetermined amount or (2) the number of inbound control packets received over a certain amount of time has fallen below a predetermined amount.

If an upper threshold level has been exceeded, the process proceeds to step 706 to begin allocation of additional communication channels for the control plane (also referred to as control plane expansion). If the throughput has fallen below a lower threshold, the process proceeds to step 716 to begin de-allocation of control channels from the control plane (also referred to as control plane contraction). If the throughput has neither exceeded the upper threshold nor fallen below the lower threshold, the process returns to step 702.

Turning first to step 706, the control plane allocation manager 302 begins expansion procedures by transmitting to the appropriate zone controller 108 a request for an additional control channel to be allocated for the base site 104. In response to receiving the request, the zone controller 108 initially determines whether a communication channel is available for allocation, for example, by determining whether there are any currently unused communication channels or whether a maximum number of control channels have already been allocated for the base site 104. If available, the zone controller 108 allocates a new communication channel to the control plane and transmits a grant signal to the site controller informing the site controller that a new communication channel has been so allocated. Upon receiving the grant signal, the site controller assigns the allocated communication channel as a control channel in step 708.

In step 710, the control plane allocation manager 302 determines how to distribute the talkgroups registered at the base site 104 among the multiple control channels. In one embodiment, this is accomplished based on information stored in the use database 306. For example, it may be desirable to ensure that frequently used talkgroups are distributed among multiple control channels in order to decrease the load placed on any one particular control channel.

In step 712, the control plane allocation manager 302 issues a move message that is then broadcast to each talkgroup which needs to move to a new control channel in order to obtain the distribution determined in step 710. Thus, the move message contains information instructing each communication unit receiving the move message to move to the appropriate control channel. In one embodiment, the move message for each talkgroup is transmitted on the control channel currently assigned to that talkgroup, based on information stored in the allocation database 308. However, the move message for each talkgroup may also be transmitted on all control channels simultaneously. The move message may also be transmitted multiple times to ensure that it is received by each communication unit.

After the move message has been transmitted, the allocation database 308 is updated to indicate the new associations between talkgroups and control channels in step 714. In one embodiment, the update of the allocation database 308 may occur upon the transmission of the move message. Alternatively, the site controller may also be configured to update the allocation table only upon receiving an indication from a communication unit that it has moved to the new control channel.

Turning now to step 716, if the throughput level falls below a lower threshold, contraction procedures are initiated by the control plane allocation manager 202 by first selecting a control channel that is to be de-assigned from the control plane. In one embodiment, the control channel to be de-assigned may simply be the control channel whose throughput level has fallen below the lower threshold, although it is understood that other control channels may also be selected. Although not illustrated in FIG. 7, it should also be understood that if only one control channel is currently in use, no contraction procedures would be implemented.

In step 718, the control plane allocation manager 302 determines how to distribute the talkgroups among the remaining control channels once the selected control channel is de-allocated. In one embodiment, this is accomplished based on information stored in the use database 305. For example, as discussed above with respect to step 710, it may be desirable to ensure that frequently used talkgroups are distributed among multiple control channels, if available, in order to decrease the load placed on any one particular control channel.

Once the distribution of talkgroups has been determined in step 718, the control plane allocation manager 302 begins the process of moving each talkgroup previously assigned to the selected control channel to another control channel. In particular, for each talkgroup on the selected control channel, it is determined whether the talkgroup is idle (i.e., not presently transmitting or receiving a call) in step 720. If no talkgroup is idle, the process remains at step 720. If a talkgroup is determined to be idle, the control plane allocation manager 302 issues a move message that is broadcast to the idle talkgroup in step 722, instructing each communication unit in the talkgroup to move to the appropriate control channel. The allocation database 308 is updated to reflect the new control channel for that talkgroup in step 724. As above, allocation database 308 may be updated upon transmission of the move message or alternatively, upon receiving an indication from a communication unit that it has moved to the new control channel.

In step 726, it is determined whether there are any talkgroups remaining on the selected control channel which have not yet been instructed to move to a new control channel. If there are still talkgroups remaining on the selected control channel, the process returns to step 720. If no more talkgroups are remaining on the selected channel, the control plane allocation manager 302 transmits to the zone controller 108 a request to de-allocate the selected control channel from the control plane. In response to receiving the request, the zone controller 108 de-allocates the selected control channel and informs the base site 104 that the selected control channel has been de-allocated. The base site then de-assigns the selected control channel from the control plane in step 730, and the process returns to step 702.

By means of the above described disclosure, a system and method is provided to permit a base site 104 to dynamically allocate resources to the control plane based on call activity. As a result, additional communication channels can be utilized for control plane signaling when call activity is high, and fewer communication channels can be utilized for control plane signaling when call activity is low.

Hysteresis routines or the like may also be implemented to ensure that neither expansion or contraction procedures are implemented prematurely. For example, the control plane allocation manager 302 may only initiate expansion procedures if the throughput level for a control channel exceeds an upper threshold for a predetermined amount of time. Similarly, the control plane allocation manager 302 may only initiate contraction procedures if the throughput level for a control channel falls below a lower threshold for a predetermined amount of time.

Of course, it will also be understood that the present disclosure may also be configured to dynamically allocate resources to the control plane based on criteria other than call activity. For example, in one embodiment, call resources may be dynamically allocated in response to detection of communication channel failures. Thus, if the control plane allocation manager 302 detects that a control channel has failed, the control plane allocation manager 302 may allocate a new control channel to take over for the failed control channel using a similar process as described in steps 706 through 714. As a result, communication channels need not be reserved for providing backup control channels.

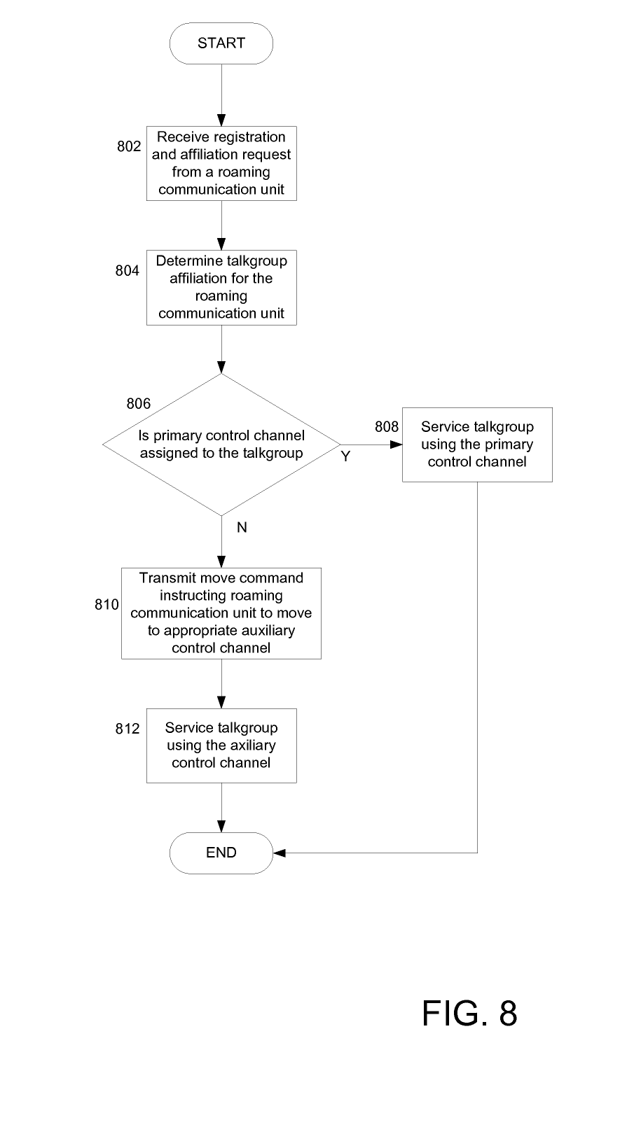

Let us now discuss several additional aspects for managing a communication system in which multiple control channels may be simultaneously utilized at a single base site 104. FIG. 8 illustrates one exemplary embodiment for managing communication units roaming amongst base sites utilizing multiple control channels (i.e., communication units moving from one base site to another). In this embodiment, it is assumed that one control channel at each base site 104 is designated as a primary control channel, and that the primary control channel is the only control channel that is advertised by the base site to roaming communication units. Control channels other than the primary control channel are referred to as auxiliary control channels.

In step 802, registration and affiliation request messages are received by a base site 104 via the primary control channel indicating that a communication unit 206 has roamed to the base site 202. Upon receiving the registration and affiliation request messages, the base site 104 determines the talkgroup with which the roaming communication unit is affiliated in step 804 (for example, by reference to association database 308).

In step 806, it is determined whether the talkgroup identified in step 804 is assigned to the primary control channel. If it is, the roaming communication unit remains on, and continues to be serviced by, the primary control channel in step 808. However, if the talkgroup is not assigned to the primary control channel, the base site transmits a move command to the roaming communication unit instructing the roaming communication unit to move to the auxiliary control channel that is assigned to the talkgroup, in step 8 10. That auxiliary control channel is then used to service the roaming communication unit in step 812.

In one embodiment, it may also be desirable that the upper threshold level used for determining whether to initiate expansion procedures is set higher for the primary control channel than the upper threshold level for auxiliary control channels. More particularly, the upper threshold level for the primary control channel is preferably set sufficiently high to accommodate control plane traffic for a certain amount of communication units roaming to the base site without triggering expansion procedures.

Call requests attempted on an incorrect control channel by a communication unit 206 already registered at a base site may also be handled in a similar manner as described above for roaming. For example, if a communication unit attempts to transmit a call request message on a control channel for a talkgroup that is not assigned to that control channel, the base site may instruct the communication unit to move to the appropriate control channel associated with that respective talkgroup.

Private call and super group calls, however, may be managed in a different manner. A private call scenario arises when two communication units, which may not be in the same talkgroup, attempt to directly communication with one another. In this scenario, if the two communication units attempting a private call are utilizing different control channels, the base site may be configured to transmit appropriate control signaling (e.g., Unit to Unit signaling or U2U) on each of the respective control channels, even though only a single traffic channel will be utilized for the call. Similarly, if a super group call is initiated (i.e., a call in which multiple talkgroups are involved), control information for the super group may be sent over each control channel assigned to a talkgroup that is participating in the call.

Further advantages and modifications of the above described system and method will readily occur to those skilled in the art. For example, although the control plane allocation manager 302, the control plane traffic monitor 304, the use database 306, and the allocation database 308 are illustrated as being part of the site controller 210, it should be understood that these components may alternatively be provided in other devices at a base site. The components also need not all be contained within a single device and may therefore be distributed among multiple devices at the base site.

The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure cover all such modifications and variations provided they come within the scope of the following claims and their equivalents.

What is claimed is:

1. A method for provisioning control plane signaling capacity for a base site in a communication system, the base site being configured to communicate with a plurality of talkgroups using a plurality of communication channels, each of the plurality of talkgroups comprising a group of communication units, the method comprising:
monitoring at least one criteria of a first control channel for transmitting control plane signaling in a control plane, the first control channel being one of the plurality of communication channels;
determining, based on the at least one criteria, that additional control plane signaling capacity is required;
assigning an available communication channel as an additional control channel to transmit control plane signaling;
determining a set of talkgroups to be serviced by the additional control channel, the set of talkgroups being at least a portion of the plurality of talkgroups; and
transmitting a move message to each talkgroup in the set of talkgroups instructing communication units within the set of talkgroups to begin utilizing the additional communication channel for control plane signaling.

2. The method of claim 1 wherein monitoring at least one criteria of the first control channel includes monitoring a control plane traffic throughput level for the first communication channel; and wherein determining that additional control plane signaling capacity is required includes determining that the control plane traffic throughput level has exceeded a predetermined threshold.

3. The method of claim 2 wherein monitoring the control plane traffic throughput level includes monitoring at least one of an outbound control plane traffic throughput level for the first communication channel and an inbound control plane traffic throughput level for the first communication channel.

4. The method of claim 3 wherein monitoring the outbound control plane traffic throughput level for the first communication channel includes determining a number of control packets in an outbound queue for the first communication channel.

5. The method of claim 3 wherein monitoring the outbound control plane traffic throughput level for the first communication channel includes determining an amount of time until a selected type of control packet in an outbound queue for the first communication channel is to be transmitted.

6. The method of claim 3 wherein monitoring the inbound control plane traffic throughput level for the first communication channel includes at least one of (a) determining a number of inbound control packets received on the first communication channel over a predetermined amount of time and (b) determining a total size of inbound control packet data received on the first communication channel over a predetermined amount of time.

7. The method of claim 1 wherein the at least one criteria includes a control channel failure.

8. The method of claim 3 wherein determining that the control plane traffic throughput level has exceeded a predetermined threshold includes determining that at least one of the outbound control plane traffic throughput level and inbound control plane traffic throughput level has exceeded a predetermined threshold.

9. The method of claim 1 wherein assigning the additional communication channel as control channel includes transmitting a channel request to a zone controller requesting an available communication channel be allocated for control plane signaling.

10. The method of claim 1 wherein determining a set of talkgroups to be serviced by the additional communication channel includes determining a set of talkgroups to be serviced by the second communication channel based on an amount of bandwidth required by each of the plurality of talkgroups.

11. A method for provisioning control plane signaling capacity for a base site in a communication system, the base site being configured to communicate with a plurality of talkgroups using a plurality of communication channels, each of the plurality of talkgroups comprising a group of communication units, the method comprising:
monitoring at least one criteria of a plurality of control channels for transmitting control plane signaling in a control plane;
determining, based on the at least one criteria, that the control plane signaling capacity should be decreased;
selecting a control channel from the plurality of control channels to be de-assigned from the control plane;
transmitting a move message to a set of talkgroups associated with the selected control channel instructing the communication units within the set of talkgroups to begin utilizing one of the plurality of control channels other than the selected control channel for control plane signaling; and
de-assigning the selected control channel from the control plane.

12. The method of claim 11 wherein monitoring at least a one criteria includes monitoring a control plane traffic throughput level for the plurality of control channels; and wherein determining that the control plane signaling capacity should be decreased includes determining that the control plane traffic throughput level for at least one of the plurality of control channels has fallen below a predetermined threshold.

13. The method of claim 11 wherein monitoring the control plane traffic throughput level includes monitoring at least one of an outbound control plane traffic throughput level for the first communication channel and an inbound control plane traffic throughput level for the first communication channel.

14. The method of claim 13 wherein monitoring the outbound control plane traffic throughput level for the first communication channel includes determining an amount of time until a selected type of control packet in an outbound queue for the first communication channel is to be transmitted.

15. The method of claim 11 further including determining whether each talkgroup in the set of talkgroups is idle and transmitting the move message to each talkgroup in the set of talkgroups upon determining that the talkgroup is idle.

16. The method of claim 11 wherein de-assigning the selected control channel includes transmitting a request to a zone controller requesting the selected control channel be de-allocated from the control plane.

17. A system for provisioning control plane signaling capacity including:
a plurality of talkgroups, each of the plurality of talkgroups including a plurality of communication units;
a base site in wireless communication with each of the plurality of talkgroups via a plurality of communication channels, wherein at least a first portion of the plurality of communication channels are capable of being configured as control channels;
a control plane monitor located at the base site for monitoring at least one criteria of at least one control channel;
a use database located at the base site for recording information regarding an amount of bandwidth required by each of the plurality of talkgroups for communicating with the base site;
an allocation database located at the base site for recording information identifying which control channel is servicing each one of the plurality of talkgroups; and
a control plane allocation manager located at the base site and coupled to the control plane traffic monitor, the use database, and the allocation database;
the control plane allocation manager being configured to determine, based on the at least one criteria, that additional control plane signaling capacity is required; assign an available communication channel as an additional control channel to transmit control plane signaling; determine a first set of talkgroups to be serviced by the additional control channel, and initiate transmission of a move message to each talkgroup in the first set of talkgroups instructing communication units within the first set of talkgroups to begin utilizing the additional communication channel for control plane signaling,
the control manager being further configured to determine, based on the at least one criteria, that the control plane signaling capacity should be decreased; select a control channel from the at least one of the control channels to be de-assigned from the control plane; initiate transmission of a move message to each talkgroup in a second set of talkgroups associated with the selected control channel instructing the communication units within the second set of talkgroups to begin utilizing a control channel other than the selected control channel for control plane signaling; and de-assign the selected control channel from the control plane.

18. The system of claim 17 wherein the control plane monitor is configured to monitor a traffic throughput level for the at least one control channel, and wherein the control plane allocation manager is configured to determine that additional control plane signaling capacity is required upon the traffic throughput level exceeding a first threshold, and wherein the control plane allocation manager is configured to determine that the control plane signaling capacity should be decreased upon the traffic throughput level falling below a second threshold.

19. The system of claim 1 wherein the control plane allocation manager determines the first set of talkgroups to be serviced by the additional control channel based on information recorded in the use database,

20. The system of claim 1 wherein each of the control plane monitor, the use database, the allocation database, and the control plane allocation manager are located within a site controller at the base site.
